(19) United States
(12) Patent Application Publication
(10) Pub. No.: US 2026/0141178 A1
(43) Pub. Date: May 21, 2026

(54) INFORMATION PROCESSING DEVICE, INFORMATION PROCESSING METHOD, AND RECORDING MEDIUM

(71) Applicant: NEC Corporation, Tokyo (JP)

(72) Inventor: Yuichi YANO, Tokyo (JP)

(73) Assignee: NEC Corporation, Tokyo (JP)

(21) Appl. No.: 19/385,217

(22) Filed: Nov. 11, 2025

(30) Foreign Application Priority Data
Nov. 20, 2024 (JP) 2024-202292

(51) Int. Cl. G06F 40/295; G06F 40/40

(52) U.S. Cl. CPC G06F 40/295; G06F 40/40

(57) ABSTRACT

In an information processing device, an extraction means extracts entities and a relationship between the entities from natural language data. A determination means determines truthfulness of the relationship between the entities. A graph construction means adds the relationship between the entities determined to be true by the determination means to a knowledge graph, and does not add the relationship between the entities determined to be false by the determination means to the knowledge graph. For example, the constructed knowledge graph can be used in machine learning to perform various prediction tasks and to support decision-making related to prediction tasks.

### INCORPORATION BY REFERENCE

This application is based upon and claims the benefit of priority from Japanese patent application No. 2024-202292, filed on Nov. 20, 2024, the disclosure of which is incorporated herein in its entirety by reference.

### TECHNICAL FIELD

The present disclosure relates to a technique of constructing a knowledge graph.

### BACKGROUND ART

Knowledge graphs that represent knowledge in various fields have been developed and utilized. For example, Patent Document 1 proposes a technique of constructing a knowledge graph customized for an application.

Patent Document 1: Japanese Patent 2024-023311 A

### SUMMARY

However, even in a case of Patent Document 1, a highly accurate knowledge graph may not necessarily be constructed.

An object of the present disclosure is to provide an information processing device capable of constructing a highly accurate knowledge graph.

According to an example aspect of the present invention, there is provided an information processing device, including:
at least one memory configured to store instructions; and
at least one processor configured to execute the instructions to:
extract entities and a relationship between the entities from natural language data;
determine truthfulness of the relationship between the entities; and
add the relationship between the entities determined to be true to a knowledge graph and not add the relationship between the entities determined to be false to the knowledge graph.

According to another example aspect of the present invention, there is provided an information processing method including:
extracting entities and a relationship between the entities from natural language data;
determining truthfulness of the relationship between the entities; and
adding the relationship between the entities determined to be true to a knowledge graph and not adding the relationship between the entities determined to be false to the knowledge graph.

According to a further example aspect of the present invention, there is provided a recording medium recording a program for causing a computer to execute processing including:
extracting entities and a relationship between the entities from natural language data;
determining truthfulness of the relationship between the entities; and
adding the relationship between the entities determined to be true to a knowledge graph and not adding the relationship between the entities determined to be false to the knowledge graph.

According to the present disclosure, it becomes possible to provide an information processing device capable of constructing a highly accurate knowledge graph.

### BRIEF DESCRIPTION OF THE DRAWINGS

FIG. 1 is a diagram conceptually illustrating an information processing device according to the present disclosure;

FIG. 2 is a block diagram illustrating a hardware configuration of the information processing device according to the present disclosure;

FIG. 3 is a block diagram illustrating a functional configuration of the information processing device according to the present disclosure;

FIG. 4 is an example of natural language data;

FIG. 5 is an example of an extracted entity;

FIG. 6 is an example of a prompt by a relationship extraction unit;

FIG. 7 is an example of an LLM response;

FIG. 8 is an example of a prompt by a relationship extraction confirmation unit;

FIG. 9 is another example of the LLM response;

FIG. 10 is a flowchart of a process performed by the information processing device according to the present disclosure;

FIG. 11 is a block diagram illustrating a functional configuration of another information processing device according to the present disclosure; and

FIG. 12 is a flowchart of a process performed by the another information processing device according to the present disclosure.

### EXAMPLE EMBODIMENTS

Hereinafter, preferred example embodiments of the present disclosure will be described with reference to the drawings.

### First Example Embodiment

### Overall Configuration

In the fields of medicine and drug discovery, there is a wealth of data written in natural language, such as papers and electronic medical records. By constructing a knowledge graph from such natural language data, a relationship between data may be expressed, which may be utilized for advanced search, predictive tasks, and the like.

The knowledge graph is constructed by using, for example, a large language model (LLM). However, according to the method described above, there has been a possibility that a knowledge graph different from the fact described in the original natural language data is constructed if the LLM causes hallucination (i.e., if the LLM generates erroneous information).

In view of the above, in the present example embodiment, a process of checking whether the knowledge graph matches the fact described in the original natural language data is included at the time of constructing the knowledge graph. As a result, a highly accurate knowledge graph based on the fact described in the original natural language data is constructed.

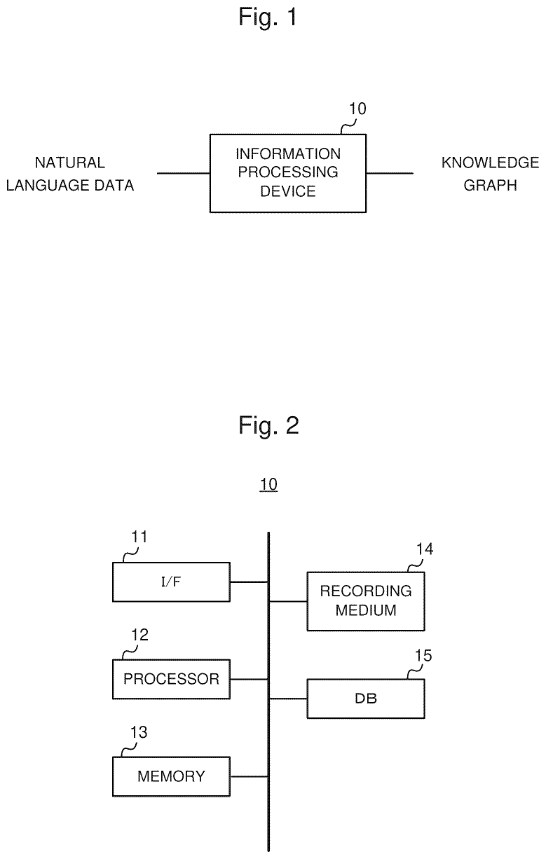

FIG. 1 is a diagram conceptually illustrating an information processing device according to the present example embodiment. An information processing device 10 constructs a knowledge graph from the input natural language data, such as papers. First, the information processing device 10 extracts, using the LLM, a list of triples (node, edge, node) from the natural language data. A node represents an entity, and an edge represents a relationship between nodes. Next, the information processing device 10 determines truthfulness of each triple using the LLM. The information processing device 10 adds the triples determined to be true to the knowledge graph, and excludes the triples determined to be false without adding them to the knowledge graph. In this manner, with the process of checking the truthfulness of the information (triples) obtained from the LLM being included, the information processing device 10 is enabled to construct a highly accurate knowledge graph.

While a knowledge graph in the fields of medicine and drug discovery is constructed in the present example embodiment, the target field is not limited thereto, and for example, it is applicable to other fields such as material development, pesticide development, and the like.

### Hardware Configuration

FIG. 2 is a block diagram illustrating a hardware configuration of the information processing device 10 according to the first example embodiment. The information processing device 10 is an exemplary information processing device. As illustrated in the drawing, the information processing device 10 includes an interface (I/F) 11, a processor 12, a memory 13, a recording medium 14, and a database (DB) 15.

The I/F 11 exchanges data with an external device. Specifically, the I/F 11 obtains, from the external device, natural language data to be used by the information processing device 10.

The processor 12 is a computer such as a central processing unit (CPU), and takes overall control of the information processing device 10 by executing a program prepared in advance. The processor 12 may be a graphics processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof. The processor 12 executes a knowledge graph construction process to be described later.

The memory 13 includes a read only memory (ROM), a random access memory (RAM), and the like. The memory 13 is also used as a work memory during execution of various types of processing by the processor 12.

The recording medium 14 is a non-volatile non-transitory recording medium, such as a disk-shaped recording medium, a semiconductor memory, or the like, and is detachable from the information processing device 10. The recording medium 14 records various programs to be executed by the processor 12. In a case where the information processing device 10 executes various types of processing, a program recorded in the recording medium 14 is loaded into the memory 13, and is executed by the processor 12. The DB 15 stores knowledge graphs.

In addition to the above, the information processing device 10 may include a display device such as a liquid crystal display, and an input device such as a keyboard and a mouse. The display device and the input device are used by an administrator of the information processing device 10 to perform necessary management, for example.

### Functional Configuration

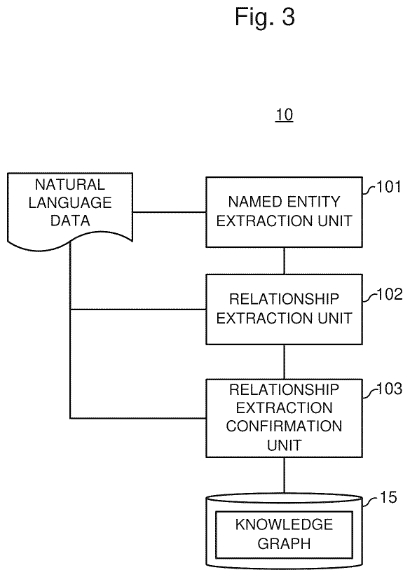

FIG. 3 is a block diagram illustrating a functional configuration of the information processing device 10 according to the first example embodiment. The information processing device 10 functionally includes a named entity extraction unit 101, a relationship extraction unit 102, and a relationship extraction confirmation unit 103.

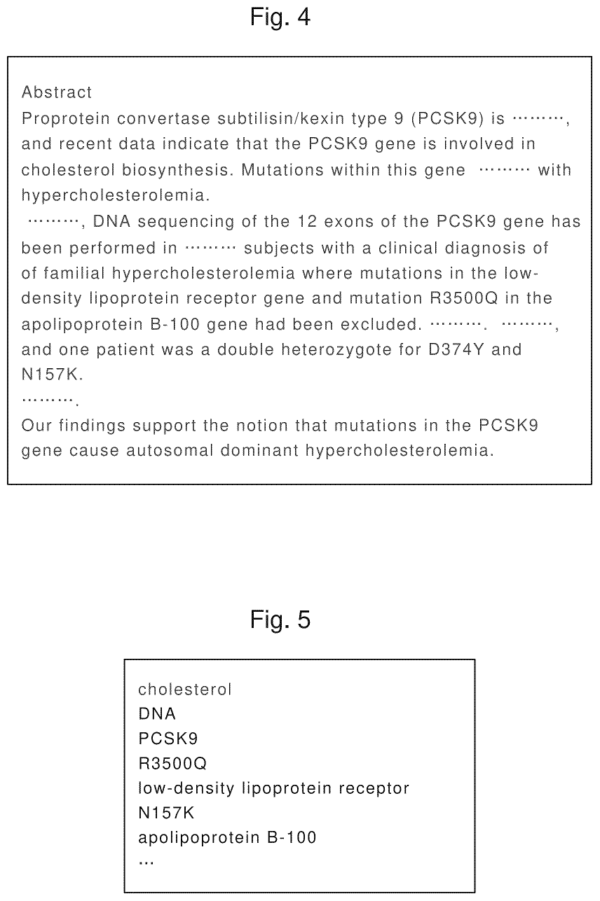

The natural language data is input to the information processing device 10 through the I/F 11. The natural language data is input to the named entity extraction unit 101, the relationship extraction unit 102, and the relationship extraction confirmation unit 103. FIG. 4 is an example of the natural language data. The natural language data of FIG. 4 is a medical paper, and is obtained from, for example, a medical literature search database.

The named entity extraction unit 101 extracts a named entity from the natural language data using a model such as an LLM. The named entity is a proper noun or a numerical expression such as a date, time, or the like. In the fields of medicine and drug discovery, examples of the named entity include a disease name, a drug name, a gene name, and a protein name. The named entity extracted by the named entity extraction unit 101 is treated as an entity candidate in the knowledge graph. The named entity extraction unit 101 outputs the extracted named entity (which will also be referred to as an “entity” hereinafter) to the relationship extraction unit 102.

FIG. 5 is an example of the extracted entity. In FIG. 5, the named entity extraction unit 101 extracts, from the natural language data of FIG. 4, entities such as cholesterol, DNA, PCSK9, R3500Q, and the like.

The relationship extraction unit 102 extracts a relationship between entities from the natural language data based on the natural language data and the entities. The relationship extraction unit 102 extracts a list of triples as a relationship between entities.

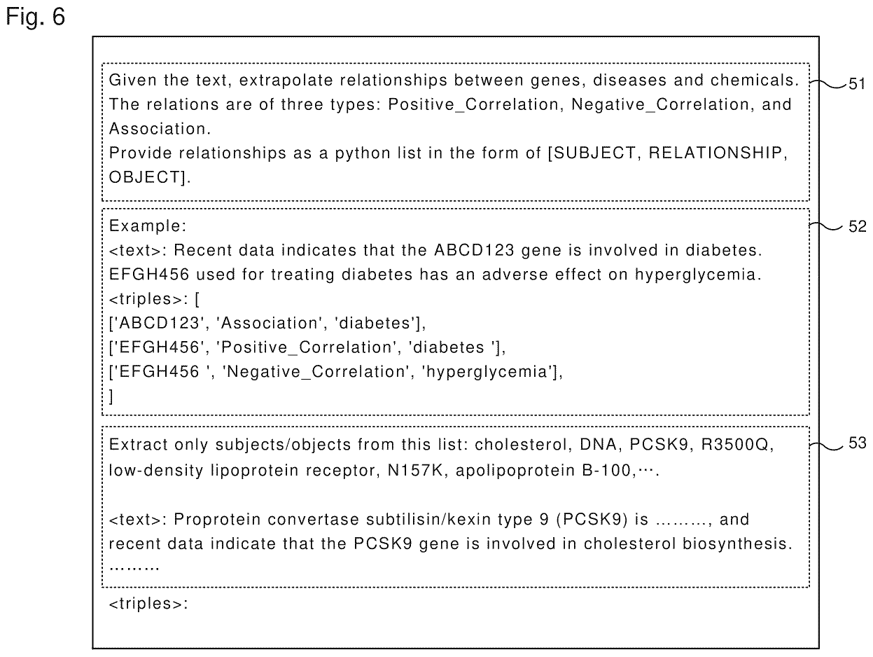

Specifically, the relationship extraction unit 102 creates a prompt as illustrated in FIG. 6, and inputs the created prompt to the LLM. The prompt is to instruct the LLM to extract the triples from the natural language data. Then, the relationship extraction unit 102 obtains a response (i.e., list of triples) to the prompt from the LLM. The relationship extraction unit 102 outputs the LLM response to the relationship extraction confirmation unit 103.

FIG. 6 is an example of the prompt by the relationship extraction unit 102. The prompt of FIG. 6 includes a directive 51, a specific example 52, and a context 53. The directive 51 is an instruction sentence for the LLM. The directive 51 includes text of instructing inference of a relationship between entities from the natural language data, text of instructing an output of a response in a form of a triple, and the like. The specific example 52 is an example of processing to be executed by the LLM. With such an example being present, the accuracy of the LLM response may be improved. The context 53 is an information source for the LLM to generate a response, and includes the entities input from the named entity extraction unit 101 and the natural language data.

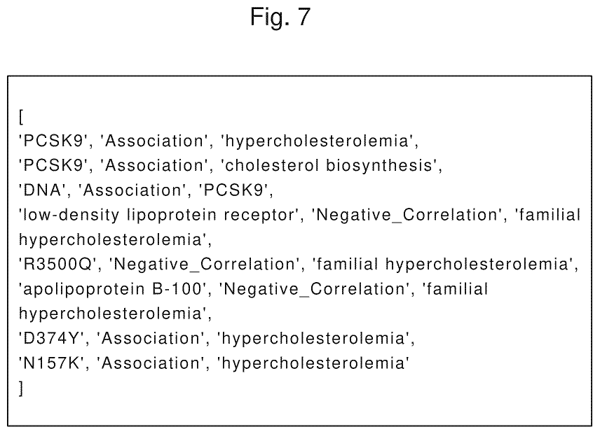

FIG. 7 illustrates an example of the LLM response. As illustrated in FIG. 7, the relationship extraction unit 102 obtains a list of triples as an LLM response.

Returning to FIG. 3, the relationship extraction confirmation unit 103 determines the truthfulness of each triple based on the natural language data and the list of the triples. “True” indicates that the triple (i.e., relationship between entities) is written in the natural language data, and “false” indicates that the triple is not written in the natural language data. The relationship extraction confirmation unit 103 constructs a knowledge graph based on a result of the truthfulness determination.

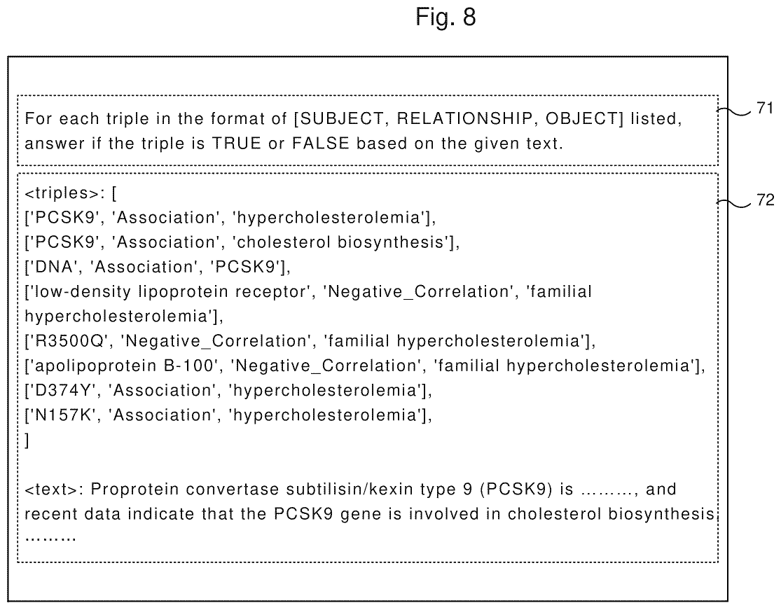

Specifically, the relationship extraction confirmation unit 103 creates a prompt as illustrated in FIG. 8, and inputs the created prompt to the LLM. The prompt is to instruct the LLM to determine the truthfulness of each triple. Then, the relationship extraction confirmation unit 103 obtains a response (i.e., truthfulness determination result) to the prompt from the LLM. If the triple is true (TRUE), the relationship extraction confirmation unit 103 adds the triple to the knowledge graph. On the other hand, if the triple is false (FALSE), the relationship extraction confirmation unit 103 excludes the triple without adding it to the knowledge graph.

FIG. 8 is an example of the prompt by the relationship extraction confirmation unit 103. The prompt of FIG. 8 includes a directive 71 and a context 72. The directive 71 is an instruction sentence for the LLM, and includes text of instructing determination of the truthfulness of each triple based on the natural language data. The context 72 is an information source for the LLM to generate a response, and includes the list of the triples input from the relationship extraction unit 102 and the natural language data.

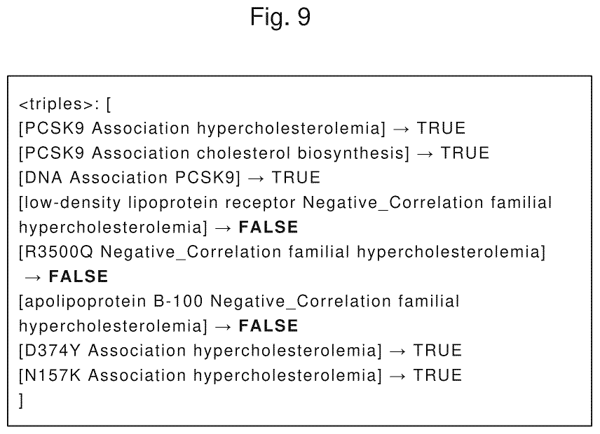

FIG. 9 illustrates an example of the LLM response. As illustrated in FIG. 9, the relationship extraction confirmation unit 103 obtains the truthfulness determination result of each triple as the LLM response. In the response illustrated in FIG. 9, three triples are determined to be false (FALSE). The relationship extraction confirmation unit 103 determines that those three triples are to be excluded from the knowledge graph.

The relationship extraction confirmation unit 103 may output the truthfulness determination result of each triple to the display device. A user may confirm whether the determination by the relationship extraction confirmation unit 103 is correct by viewing the natural language data and the display on the display device.

The named entity extraction unit 101, the relationship extraction unit 102, and the relationship extraction confirmation unit 103 may use OpenAI's Generative Pre-trained Transformer (GPT) or the like as the LLM. The LLMs to be used by the named entity extraction unit 101, the relationship extraction unit 102, and the relationship extraction confirmation unit 103 may be the same model, or may be different models. For example, the named entity extraction unit 101 may use a trained language model specialized in a domain (fields of medicine and drug discovery in the present example embodiment).

In the configuration described above, the named entity extraction unit 101 and the relationship extraction unit 102 are examples of an extraction means, and the relationship extraction confirmation unit 103 is an example of a determination means and a graph construction means.

### Knowledge Graph Construction Process

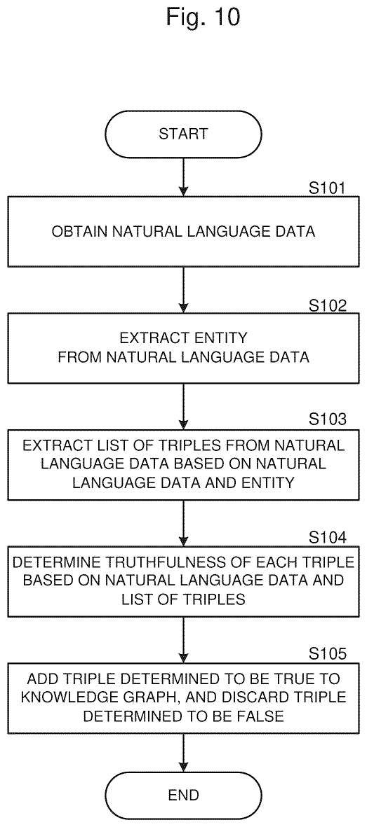

Next, a process of constructing the knowledge graph as described above will be described. FIG. 10 is a flowchart of the knowledge graph construction process performed by the information processing device 10. This process is achieved by the processor 12 illustrated in FIG. 2 executing a program prepared in advance and operating as each element illustrated in FIG. 3.

First, the natural language data is input to the information processing device 10 through the I/F 11 (step S101). The natural language data is input to the named entity extraction unit 101, the relationship extraction unit 102, and the relationship extraction confirmation unit 103.

Next, the named entity extraction unit 101 extracts entities from the natural language data using a model such as an LLM (step S102). The named entity extraction unit 101 outputs the extracted entities to the relationship extraction unit 102.

Next, the relationship extraction unit 102 extracts a list of triples from the natural language data based on the natural language data and the entities (step S103). The relationship extraction unit 102 outputs the list of the triples to the relationship extraction confirmation unit 103.

Next, the relationship extraction confirmation unit 103 determines the truthfulness of each triple based on the natural language data and the list of the triples (step S104). Next, the relationship extraction confirmation unit 103 adds the triples determined to be true to the knowledge graph, and discards the triples determined to be false (step S105). Then, the process is terminated.

### Application Example

The knowledge graph constructed by the information processing device 10 may be utilized for a semantic search, for example. The constructed knowledge graph may be utilized for various predictive tasks by being used for machine learning.

### Second Example Embodiment

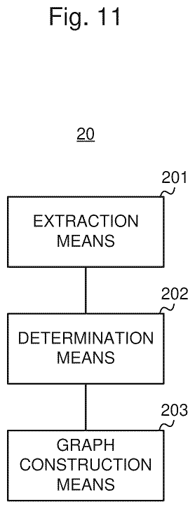

FIG. 11 is a block diagram illustrating a functional configuration of an information processing device according to a second example embodiment. An information processing device 20 includes an extraction means 201, a determination means 202, and a graph construction means 203.

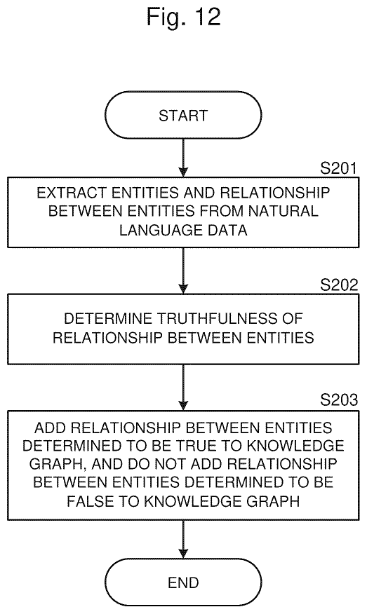

FIG. 12 is a flowchart of a process performed by the information processing device according to the second example embodiment. The extraction means 201 extracts entities and a relationship between the entities from natural language data (step S201). The determination means 202 determines truthfulness of the relationship between the entities (step S202). The graph construction means 203 adds the relationship between the entities determined to be true by the determination means to a knowledge graph, and does not add the relationship between the entities determined to be false by the determination means to the knowledge graph (step S203).

According to the information processing device according to the second example embodiment, a highly accurate knowledge graph may be constructed.

Some or all of the example embodiments described above may also be described as, but are not limited to, the following Supplementary Notes.

### Supplementary Note 1

An information processing device comprising:
an extraction means for extracting entities and a relationship between the entities from natural language data;
a determination means for determining truthfulness of the relationship between the entities; and
a graph construction means for adding the relationship between the entities determined to be true by the determination means to a knowledge graph and not adding the relationship between the entities determined to be false by the determination means to the knowledge graph.

### Supplementary Note 2

The information processing device according to supplementary note 1, wherein the determination means determines that the relationship between the entities is true in a case where the relationship matches a fact described in the natural language data, and determines that the relationship between the entities is false in a case where the relationship does not match the fact described in the natural language data.

### Supplementary Note 3

The information processing device according to supplementary note 2, wherein
the determination means determines the truthfulness of the relationship between the entities by inputting a generated prompt to a large language model, and
the prompt includes a prompt for instructing the large language model to determine the truthfulness of the relationship between the entities based on the natural language data and the relationship between the entities extracted by the extraction means.

### Supplementary Note 4

The information processing device according to supplementary note 1, wherein
the extraction means extracts a list of a triple as the relationship between the entities,
the determination means determines the truthfulness of each triple based on the natural language data and the list of the triple, and
the graph construction means adds the triple determined to be true to the knowledge graph, and does not add the triple determined to be false to the knowledge graph.

### Supplementary Note 5

The information processing device according to supplementary note 1, wherein the natural language data includes paper data and an electronic medical record.

### Supplementary Note 6

The information processing device according to supplementary note 1, wherein the extraction means extracts the entities and the relationship between the entities using a large language model.

### Supplementary Note 7

The information processing device according to supplementary note 6, wherein the extraction means extracts the entities using the large language model that has been trained and is specialized in a domain.

### Supplementary Note 8

The information processing device according to supplementary note 1, wherein the determination means outputs a result of the determination to a display device.

### Supplementary Note 9

An information processing method to be executed by a computer, the information processing method comprising:
performing extraction processing for extracting entities and a relationship between the entities from natural language data;
performing determination processing for determining truthfulness of the relationship between the entities; and
performing graph construction processing for adding the relationship between the entities determined to be true by the determination processing to a knowledge graph and not adding the relationship between the entities determined to be false by the determination processing to the knowledge graph.

### Supplementary Note 10

A program for causing a computer to perform a process comprising:
extraction processing for extracting entities and a relationship between the entities from natural language data;
determination processing for determining truthfulness of the relationship between the entities; and
graph construction processing for adding the relationship between the entities determined to be true by the determination processing to a knowledge graph and not adding the relationship between the entities determined to be false by the determination processing to the knowledge graph.

While the present disclosure has been particularly shown and described with reference to example embodiments and examples thereof, the present disclosure is not limited to these example embodiments and examples. It will be understood by those of ordinary skill in the art that various changes in form and details may be made therein without departing from the spirit and scope of the present disclosure as defined by the claims.

### DESCRIPTION OF SYMBOLS

10 Information Processing Device
101 Named Entity Extraction Unit
102 Relationship Extraction Unit
103 Relationship Extraction Confirmation Unit

1. An information processing device comprising:
at least one memory configured to store instructions; and
at least one processor configured to execute the instructions to:
extract entities and a relationship between the entities from natural language data;
determine truthfulness of the relationship between the entities; and
add the relationship between the entities determined to be true to a knowledge graph and not add the relationship between the entities determined to be false to the knowledge graph.

2. The information processing device according to claim 1, wherein the one or more processors determine that the relationship between the entities is true in a case where the relationship matches a fact described in the natural language data, and determine that the relationship between the entities is false in a case where the relationship does not match the fact described in the natural language data.

3. The information processing device according to claim 2, wherein
the one or more processors determine the truthfulness of the relationship between the entities by inputting a generated prompt to a large language model, and
the prompt includes a prompt for instructing the large language model to determine the truthfulness of the relationship between the entities based on the natural language data and the relationship between the entities extracted.

4. The information processing device according to claim 1, wherein
the one or more processors extract a list of a triple as the relationship between the entities,
the one or more processors determine the truthfulness of each triple based on the natural language data and the list of the triple, and
the one or more processors add the triple determined to be true to the knowledge graph, and do not add the triple determined to be false to the knowledge graph.

5. The information processing device according to claim 1, wherein the natural language data includes paper data and an electronic medical record.

6. The information processing device according to claim 1, wherein the one or more processors extract the entities and the relationship between the entities using a large language model.

7. The information processing device according to claim 6, wherein the one or more processors extract the entities using the large language model that has been trained and is specialized in a domain.

8. The information processing device according to claim 1, wherein the one or more processors output a result of the determination to a display device.

9. An information processing method comprising:
extracting entities and a relationship between the entities from natural language data;
determining truthfulness of the relationship between the entities; and
adding the relationship between the entities determined to be true to a knowledge graph and not adding the relationship between the entities determined to be false to the knowledge graph.

10. A non-transitory computer-readable recording medium recording a program for causing a computer to execute processing comprising:
extracting entities and a relationship between the entities from natural language data;
determining truthfulness of the relationship between the entities; and
adding the relationship between the entities determined to be true to a knowledge graph and not adding the relationship between the entities determined to be false to the knowledge graph.
